(19) United States
(12) Patent Application Publication
(10) Pub. No.: US 2007/0034264 A1
(43) Pub. Date: Feb. 15, 2007

(54) Apparatus for valve communication and control

(75) Inventors: Ross Kunz, Erhard, MN (US); Dominic Kunz, Fergus Falls, MN (US); Robert Kunz, Fergus Falls, MN (US); Robert Jenson, Detroit Lakes, MN (US); Wallace Stommes, Fergus Falls, MN (US)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: STONEL CORPORATION, Fergus Falls, MN (US)

(21) Appl. No.: 11/202,227

(22) Filed: Aug. 12, 2005

(51) Int. Cl. F16K 37/00

(52) U.S. Cl. 137/554

(57) ABSTRACT

A device for controlling a valve rotary actuator and communicating information regarding the valve rotary actuator, including a non-contact sensor which monitors, through a continuous range of rotation, the rotational position of a rotating unit connected to the valve rotary actuator, a main housing including a pneumatic valve body integrally formed with the main housing, the pneumatic valve body accommodating a valve spool, a sensor housing which supports the non-contact sensor and is connected to the main housing, and a manifold including a pathway in fluid communication with the pneumatic valve body.

### FIELD OF THE INVENTION

The invention relates to devices for indicating the status and controlling discrete automatic process valves such as, for example, air operated ball and butterfly valves. The devices typically send signals visually and electronically, indicating automatic valve parameters. One such parameter is whether the automatic valve is open or closed. The devices also control the flow of air into the automatic valve actuator which drives the process valve to a predetermined position.

### BACKGROUND OF THE INVENTION

Automatic valves are used throughout industry when fluid processes are to be controlled by PLCs or other logic devices. The automatic valves typically operate using an electric solenoid and pneumatic actuator or, an electric motor to cause a process valve to block or permit fluid flow inside a pipe.

When pneumatic actuators are used to operate the process valve, another, smaller valve (pilot valve) is often used to supply pressurized gas (usually air) to one end of an air cylinder inside the pneumatic actuator while venting the opposite end. The air cylinder is connected via a rack and pinion arrangement, or via linkages to a shaft. As the pressure on one side of the cylinder moves a rod in the cylinder toward the vented end of the cylinder, the shaft rotates in place. The shaft is attached to a valve component such as a ball or butterfly device positioned in the path of fluid flow in a pipe. In order to reverse the position of the automatic valve, the pressure and venting are reversed and, the cylinder inside the pneumatic actuator changes position. The change in position of the cylinder causes the shaft to rotate, and the ball or butterfly device rotates along with the shaft.

In some applications, a two-stage pneumatic valve is used to channel compressed gas to a pneumatic actuator. An example of a two-stage pneumatic valve combines pilot valves with a spool valve to control the pneumatic actuator. The pneumatic valve is normally installed near the process valve and sometimes is mounted on the actuator of the process valve itself.

In complex processing plants, a computer control system may control a large number of actuators. Depending on the type of process control program used, process control interlocks in the computer control system may require confirmation of actual valve position in order to continue a specified sequence of operation. Additionally, partial valve stroking of the process valve may be required. Accordingly, sensors allowing remote monitoring of the valve actuators are, in most applications, mounted on the valve actuators.

In order to optimize performance, save space, and maximize efficiency of the valve communication terminal and the pneumatic valve, it is desirable to combine these components into an integrated assembly. By doing so, electrical compatibility between the various components is assured. For example, pneumatic valve power requirements are matched to the valve communication terminal output. Diagnostics for the pneumatic valve and process valve/actuator may be performed more reliably with performance parameters measured at a valve communication terminal directly attached to the pneumatic valve system. Classifications for hazardous areas may also be satisfied more conveniently and confidently by use of a single, integrated unit which is third party approved and fully certified for the specific environmental requirement.

Previous attempts to integrate communication/control and pneumatic valves together have typically required substantial additional space and complexity as compared to standardized automated valve assemblies where the pneumatic valve and valve communication terminal are attached directly and separately to the actuator. Accordingly the inventors developed the present invention.

### SUMMARY OF THE INVENTION

The present invention provides a compact, durable, modular communication and control platform which combines position sensing and pneumatic control capabilities into a single, integrated package.

One aspect of the present invention includes a device for controlling a valve rotary actuator and communicating information regarding the valve rotary actuator, including, a non-contact sensor which monitors, through a continuous range of rotation, the rotational position of a rotating unit connected to an actuator shaft of the valve rotary actuator, a main housing including a pneumatic valve body integrally formed with the main housing, the pneumatic valve body accommodating a valve spool, a sensor housing which supports the non-contact sensor and is connected to the main housing, and a manifold including at least one pathway in fluid communication with the pneumatic valve body.

Another aspect of the present invention includes a device for controlling a valve rotary actuator and communicating information regarding the valve rotary actuator, including a means for monitoring, through a continuous range of rotation, the rotational position of a valve rotary actuator, a main housing including a pneumatic valve body integrally formed with the main housing, the pneumatic valve body accommodating a valve spool, a means for supporting the means for monitoring the rotational position of a valve rotary actuator; and a manifold including a plurality of pathways in fluid communication with the pneumatic valve body.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1a shows a perspective view of a communication and control device with external pneumatic tubing attached to a rotary valve actuator mounted on a process valve;

FIG. 1b shows a perspective view of a communication and control device attached to a rotary valve actuator mounted on a process valve and with air connections between the control and control device and rotary valve actuator made internally;

FIG. 2 shows a frontal view of communication and control device mounted on a rotary valve actuator with linking explosion proof module (LEM);

FIG. 3a shows an exploded view of an assembly including, solenoid valves, a communication module, main housing with integrated pneumatic spool valve and housing cover;

FIG. 3b is a cut-away view of a main housing such that internal construction of an integrally formed spool valve is visible.

FIG. 4a is a perspective view of a sensor module separated from a rotating unit;

FIG. 4b is a perspective view of a sensor module mounted on a rotating unit;

FIG. 5a shows a frontal section view of a sensor module before assembly with a rotating unit;

FIG. 5b shows a frontal section view of a sensor module in position to sense rotation of a rotating unit;

FIG. 5c is a schematic representation of a sensor with magnetic flux passing through it;

FIG. 6 is an exploded view of an LEM with an intrinsically safe barrier;

FIG. 7a is a perspective view of an electronic control module mounted on a main housing and dedicated I/O;

FIG. 7b is a schematic representation of an electronic control module with connections to external pilot valves;

FIG. 7c is a schematic representation of an electronic control module with connections to external pilot valves, dedicated I/O and a wireless transceiver;

FIG. 7d is a schematic representation of an electronic control module with optional pressure sensors, current sensors, auxiliary inputs and bus communication interface;

FIG. 7e is a schematic representation of an electronic control module with optional pressure sensors, current sensors, auxiliary inputs, bus communication interface and wireless transceiver;

FIG. 7f is a schematic representation of an electronic control module with optional pressure sensors, current sensors, auxiliary inputs and wireless transceiver;

FIG. 8a is a schematic representation of communication and control units connected to an operating system;

FIG. 8b is a schematic representation of a conventional communication and control network combined with wireless diagnostics;

FIG. 8c is a schematic representation of communication and control units connected to an operating system via a bus network;

FIG. 8d is a schematic representation of communication and control units connected to an operating system via a bus and to an asset management server via wireless connection;

FIG. 8e is a schematic representation of communication and control units connected to a power source via wires and connected to an operating system wirelessly;

FIG. 8f is a diagram showing typical bus implementation of a communication circuit in an electronic control;

FIG. 8g is a diagram showing implementation of a communication circuit using a bus and wireless communication.

### DETAILED DESCRIPTION

Referring now to the drawings, wherein like reference numerals designate identical or corresponding parts throughout the several views.

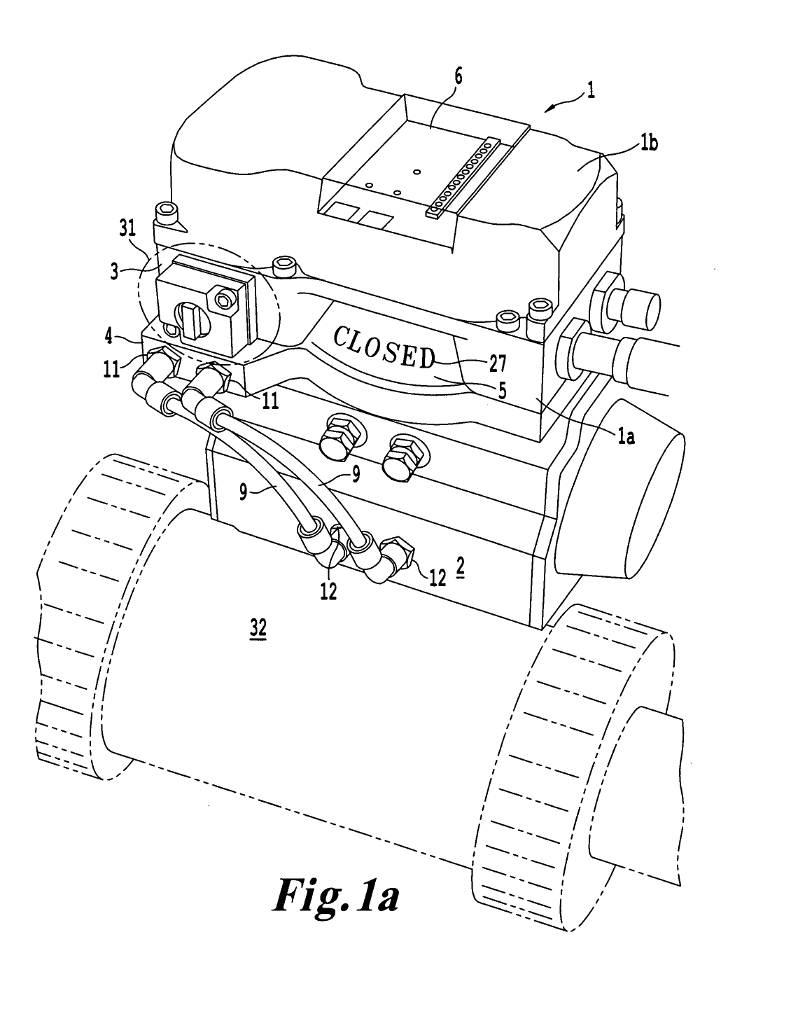

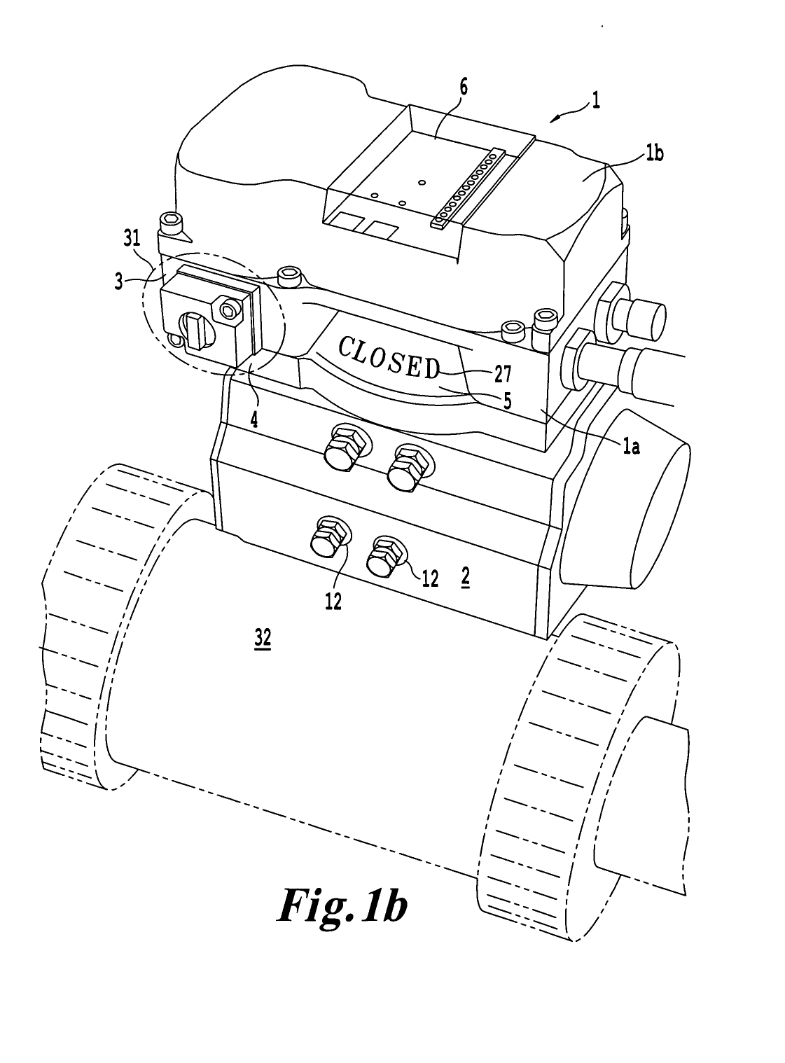

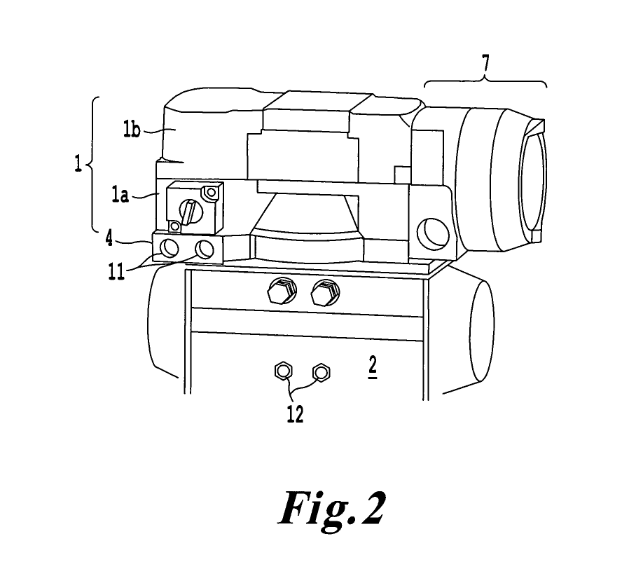

In the non-limiting example shown in FIGS. 1a, 1b and 2, a communication and control device 1 is attached to a rotary valve actuator 2. The rotary valve actuator is attached to a process valve 32. The control device 1 is typically divided into two main parts, housing cover 1b and main housing 1a. In this particular example, the rotary valve actuator 2 complies with NAMUR accessory design parameters, and the main housing 1a attaches to the rotary valve actuator 2 via a hole pattern in compliance with the NAMUR accessory standard. However, the invention may work with valve actuators that comply with other mounting standards and with valve actuators that do not comply with any standard for mounting accessories.

The rotary valve actuator 2 typically controls a process valve 32 such as a ball valve or butterfly valve mounted in line with a pipe (not shown), but other types of devices may be implemented. For example, the communication and control device 1 may be used with other types of rotary valve actuator accessories such as dampers and diaphragm valves.

In an embodiment where external tubing is used, the rotary valve actuator 2 receives air signals via rotary valve actuator ports 12. In this document, it is to be understood that when the term “air” is used, other gases such as, for example, nitrogen, can be substituted. The air signal is typically a supply of pressurized air to one of the rotary valve actuator ports 12 and a vent or open path for air flow from the other rotary valve actuator port 12. In one non-limiting embodiment, external tubing 9 connects the rotary valve actuator ports 12 to manifold 4 via external manifold ports 11. In another embodiment, the manifold 4 is in direct fluid communication with the rotary valve actuator 2 via internal manifold porting and no external tubing is necessary.

In this example, the manifold 4 is easily detachable from the rotary valve actuator 2. This detachability facilitates cleaning and repair of components inside the communication and control device 1 without requiring removal of the rotary valve actuator 2 from the process valve. Additionally, the rotary valve actuator 2 and process valve 32 may be removed and replaced without removing the communication and control device 1 from the area where the process valve 32 is installed.

Pneumatic spool valve body 3 is in fluid communication with the manifold 4. A spool 23 (shown in FIG. 9) shifts position in the pneumatic spool valve body in order to switch the air signal supplied to the rotary valve actuator 2. Together, the pneumatic spool valve body 3 and spool 23 make a pneumatic spool valve 31. Thus, the rotary valve actuator 2 will open or close the process valve 32 in response to a change in the open/close state of the spool valve 31. The spool valve body 3 is integrally formed with the main housing 1a to create a compact, durable, easy-to-install package.

Also shown in FIGS. 1a and 1b is a rotating unit 5. The rotating unit 5 attaches to a shaft (not shown) of the rotary valve actuator 2. The shaft is rigidly connected to the ball, butterfly, or other component used for blocking fluid flow inside the process valve 32 and the shaft rotates as the ball, butterfly, or other component rotates. Rotating unit 5 may optionally have a visual indicator 27 that shows the process valve position.

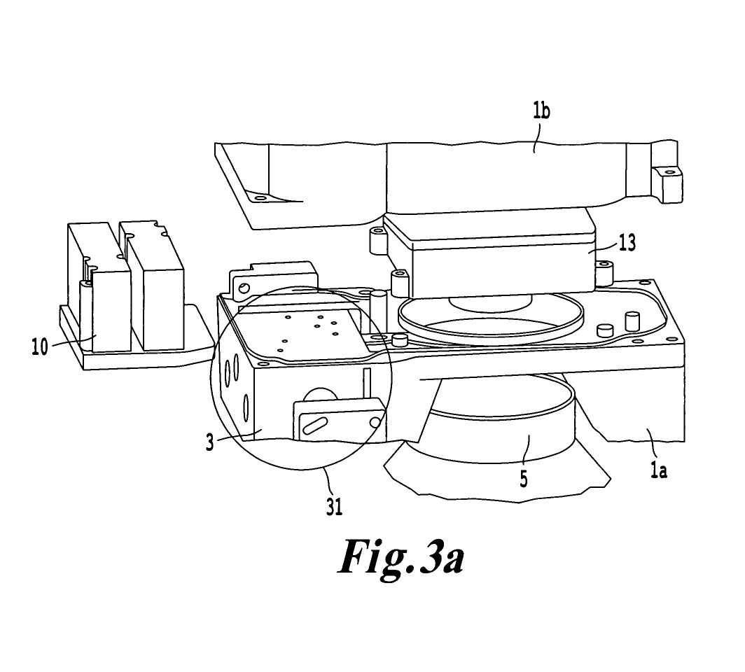

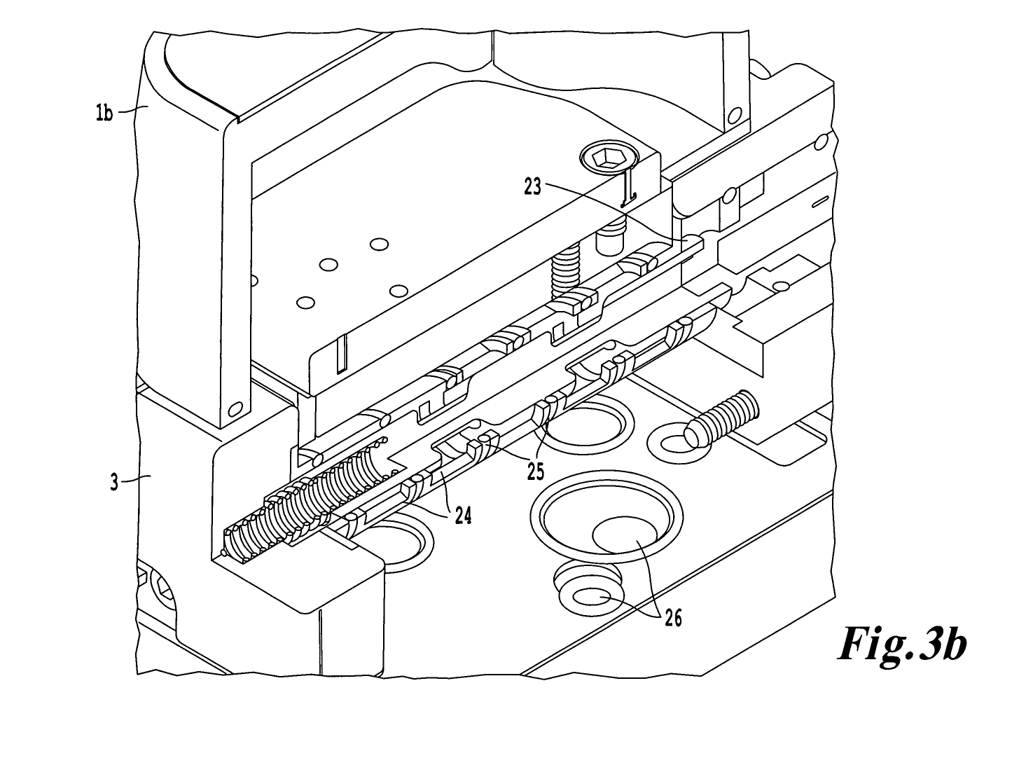

FIG. 3a shows an exploded view of one embodiment of the communication and control device 1. In this non-limiting embodiment, one or more modular pneumatic pilot valves 10 mount on the main housing 1a. However, it is to be understood that it is possible to mount the modular pneumatic pilot valves 10 elsewhere. The modular pneumatic pilot valves 10 supply an air signal to the pneumatic spool valve 31. The modular pneumatic pilot valves 10 are typically solenoid valves or piezo-valves designed to respond to an electrical signal. When solenoids valves are used to actuate the modular pneumatic pilot valves 10, the solenoids may be configured to operate at a variety of voltages. Common solenoid operating voltages include: 12 VDC, 24 VDC, and 110 VAC, but other voltages may be used.

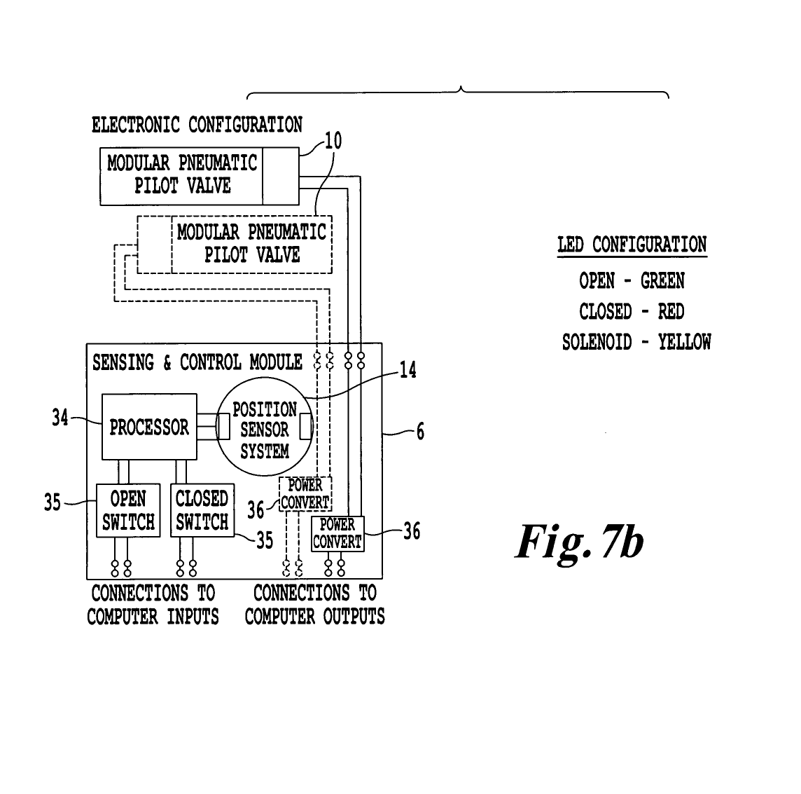

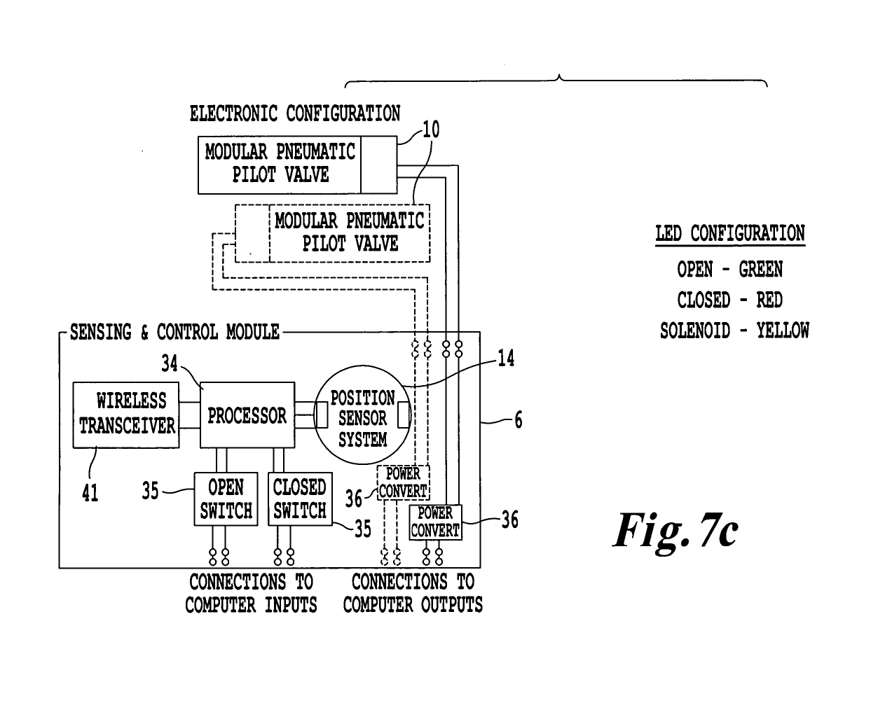

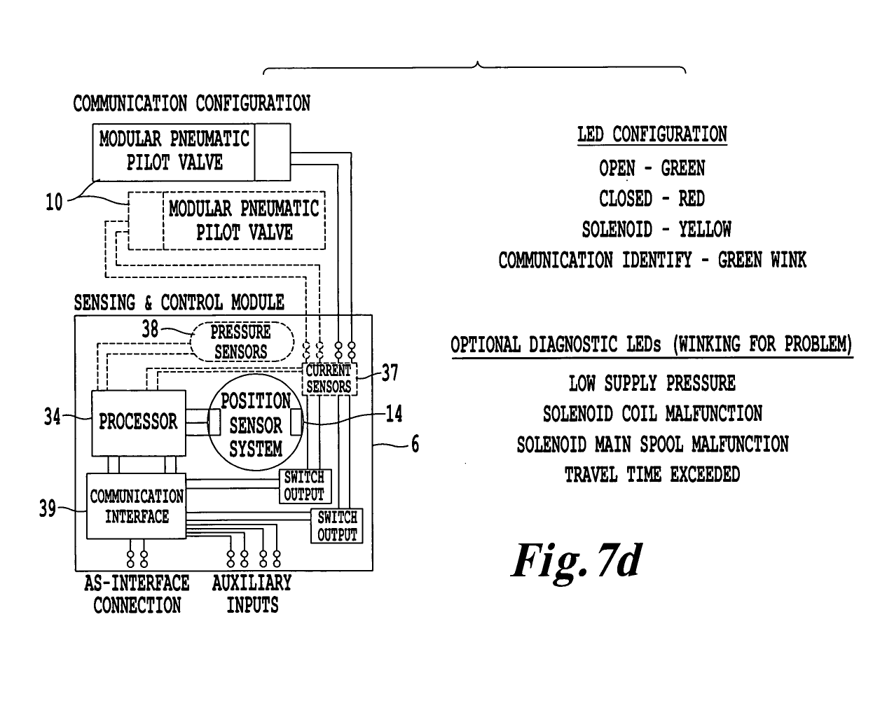

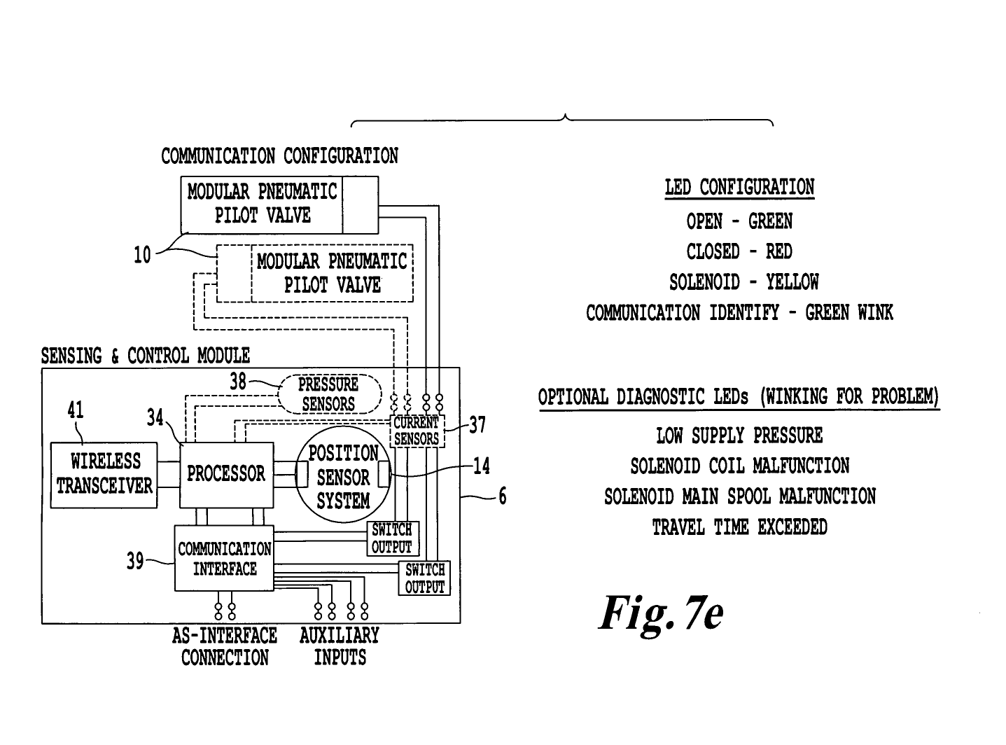

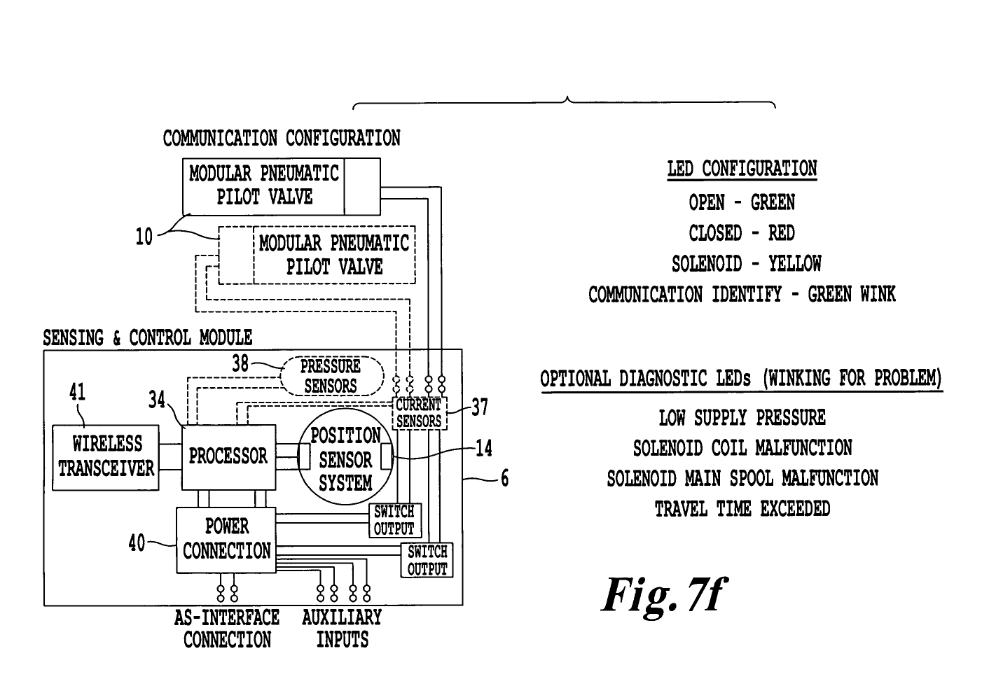

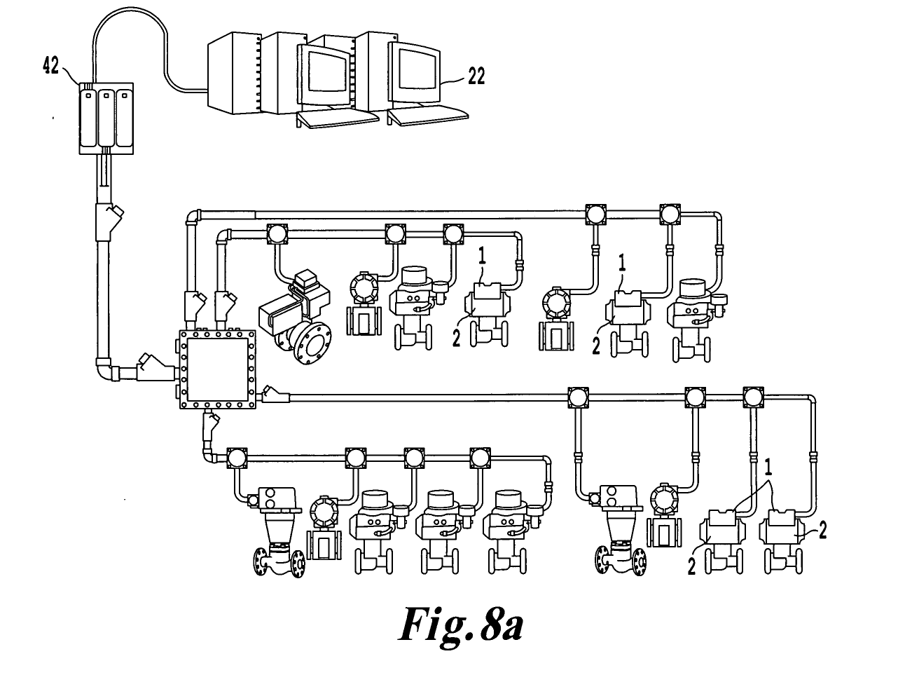

In one non-limiting embodiment, the communication and control device 1 may be configured to allow the modular pneumatic pilot valves 10 to operate on more than one type of voltage supply. For example, the modular pneumatic pilot valves 10 may operate whether the communication and control device 1 receives either 24 VDC or 120 VAC from a power supply. This result is achieved by use of a power converter 36 which includes a voltage regulator and rectifying circuit. See FIG. 7b.

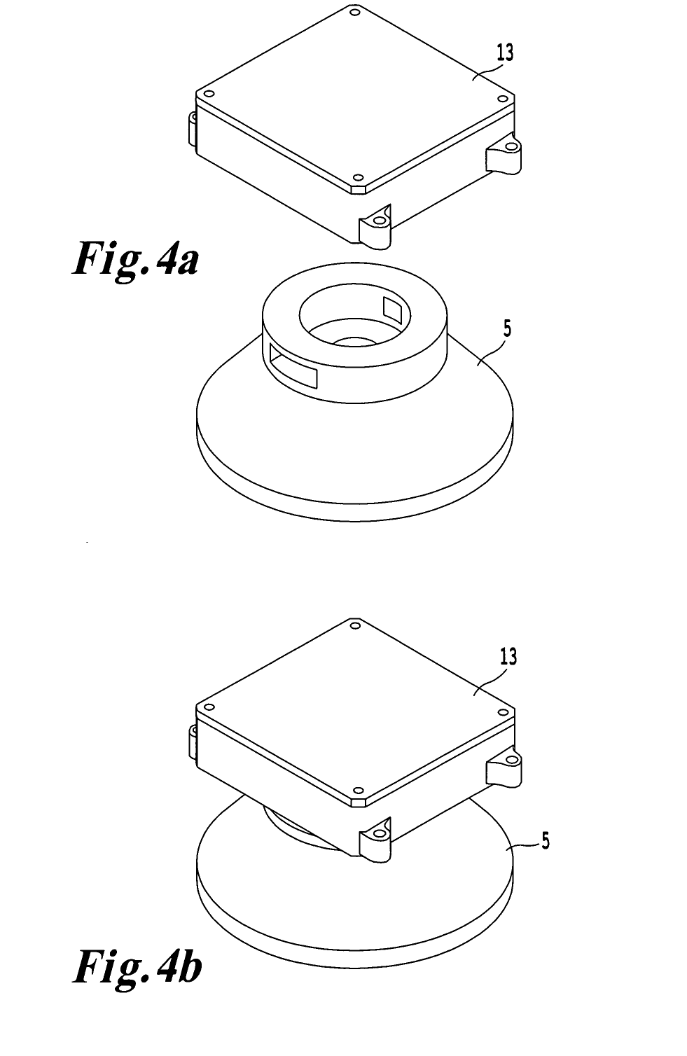

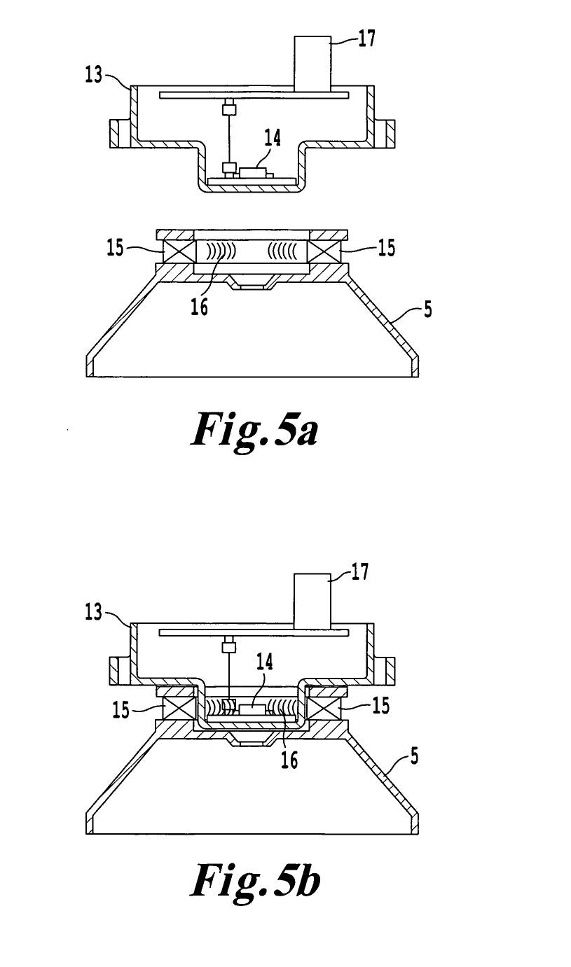

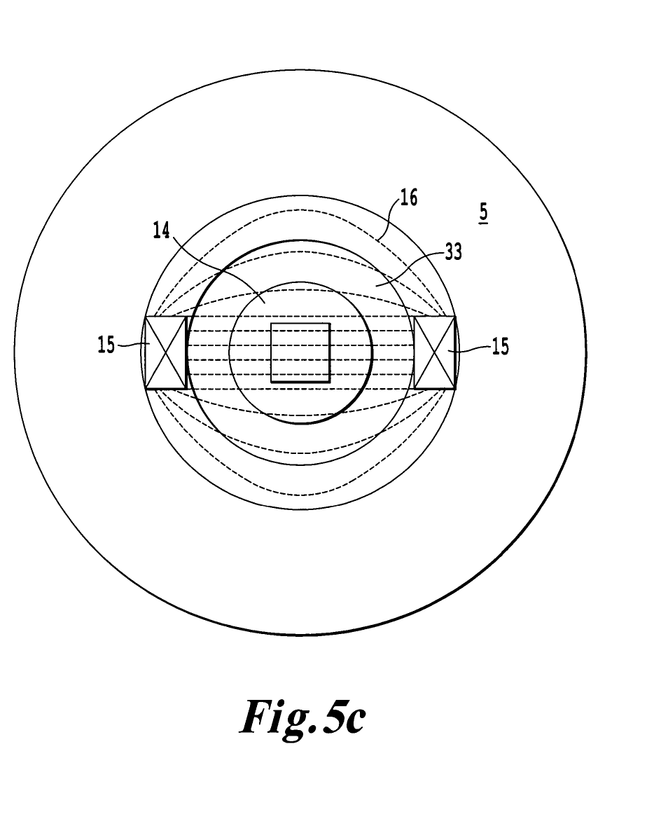

Also shown in FIG. 3a is an electronic sensor module 13. In this non-limiting embodiment, the electronic sensor module 13 is located between the housing cover 1b and the main housing 1a, but other locations are possible. The function of the sensor module is further explained in the discussion of FIGS. 4a-5c.

FIG. 3b shows a cut-away of one non-limiting embodiment of the spool valve 31. The spool 23 slides back and forth along its axis in response to air signals provided by the modular pneumatic pilot valves 10. The spool has areas of reduced diameter which are used as air flow paths. The cages 25 and sealing members 24 further define the air flow paths. As the spool 23 slides, the areas of reduced diameter on the spool 23 travel past openings in the cages 25. When an area of reduced diameter lines up with an opening in a cage 25, compressed air travels through the opening and out the internal porting 26. Accordingly, the internal porting 26 supplies compressed air to the manifold 4, which further transmits the air to the rotary valve actuator 2, either via internal porting or via external tubing 9.

By incorporating the spool valve 31 in a single integrated package with the sensor module 13, it is possible to reduce the number and complexity of parts associated with controlling and monitoring a rotary valve actuator. The communication and control device 1 provides a convenient, easy-to-install package combining valve control with valve monitoring. The combination reduces the need for extra brackets or other mounting hardware and provides a convenient way of adding or removing communication and control equipment from either newly manufactured or previously installed rotary valve actuators.

FIGS. 4a and 4b show how the electronic sensor module 13 fits into the rotating unit 5. As discussed above, the rotating unit 5 typically attaches to a rotating shaft of the rotary valve actuator 2. However, the rotating unit 5 may attach or couple with the rotary actuator in other ways. Accordingly, as the shaft of the rotary valve actuator 2 rotates, so does the rotating unit 5. The electronic sensor module 13 typically does not make physical contact with the rotating unit 5. Instead, either the main housing 1a or the housing cover 1b directly supports the sensor module 13, and a gap is typically maintained between the electronic sensor module 13 and the interior of the rotating unit 5. Accordingly, as the electronic sensor module need not contact the rotating unit 5 in order to measure rotation, no shaft, springs or wearing parts are required in the sensor module 13. As the sensor module is supported, directly or indirectly, by the main housing 1a; a compact, high strength, simple package provides an integral platform for data collection and control. This configuration also improves reliability and manufacturability.

Once the housing cover 1b is attached to the main housing 1a, the sensor module 13 is typically enclosed inside the communication and control device 1. Therefore, by combining the sensor module 13 with a housing integrating the spool valve 31, both devices may be easily attached to a rotary valve actuator 3 as a single integrated unit without additional mounting brackets.

As shown in FIGS. 5a and 5b, the electronic sensor module 13 supports at least one sensor 14. The sensor 14 in this non-limiting embodiment is a magnetic-resistive sensor, but other non-contact sensors may be used. In this example, the sensor 14 works in combination with magnets 15 mounted on the rotating unit 5.

As shown in FIGS. 5a, 5b, and 5c, the magnets are preferably mounted on opposite sides of the rotating unit 5. In other words, using the center of the rotating unit 5 as the center of a circle, one of the magnets is mounted at 0° while the other is mounted at approximately 180°, but other configurations are possible. A gap 33 separates the sensor 14 from the magnets 15. The sensor 14 remains stationary while the magnets 15 rotate around the electronic sensor module 13 and sensor 14 as the rotary valve actuator 2 changes position. As shown in FIG. 5c, magnetic flux 16 between the magnets 15 passes through the sensor 14. As the magnets rotate, the sensor 14 detects a change in the direction of the magnetic flux 16 and registers the amount of rotation with the electronic control module 6. As the sensor 14 measures change in the direction of the magnetic flux 16, not the amplitude, the sensor 14 can accommodate incidental lateral and vertical movement of the magnets relative to the sensor 14 without degradation of the accuracy of the measurement of rotation. The electronic control module 6 can transmit the information collected from the sensor 14 in various forms, such as, for example, a digital signal, a 4-20 ma signal, or a 0-5 V signal.

In one non-limiting embodiment, the sensor may be configured to consume electrical power of no more than 0.5 ma, and the sensor 14 may receive the power via a branch of an electrical circuit wired in parallel with at least one other branch. The second branch carries a signal indicating whether the process valve 32 is open. Additionally, the sensor 14 may receive power from a branch of the circuit that carries a signal indicating whether the process valve 32 is closed.

While the sensor 14 may be used simply to detect the ON/OFF position of the process valve via the rotating unit 5, the sensor 14 can also be used to detect various amounts of rotation of the rotating unit 5 through a continuous range. Typical ranges of rotation are from 0-90° (a quarter turn), but other ranges are possible. In some embodiments, the communication and control device 1 may be used to control the amount of rotation of the valve rotary actuator 2 throughout the possible range of rotation of the valve rotary actuator 2.

When used to transmit a discrete ON/OFF signal, the electronic control will produce an “ON” signal or “OFF” signal corresponding to particular rotational positions of the process valve 32. For example, when the process valve is completely closed, rotation of the process valve will be 0°. For “quarter-turn” valves, when the valve is opened, the rotational value will be approximately 90°. The electronic control 6 may be programmed to turn on an LED 19 and/or transmit a signal indicating that the process valve 32 has been opened. Similarly, the electronic control 6 may be programmed to transmit a signal and/or turn on a different LED when the process valve 32 is closed.

To compensate for possible minute variations in the physical opening and closing positions of the internal components of the process valve 32, the electronic control 6 may be programmed to produce a particular dead band around the “ON” and “OFF” positions of the process valve 32. For example, although the process valve 32 may actually reach a rotational position of 90° when opened, the electronic control 6 may be set locally or via a communication network to indicate that the process valve 32 is open when the process valve 32 has in fact rotated through only 88°. Moreover, the electronic control 6 may be set to indicate that, upon the start of rotation to close the process valve 32, the valve is no longer “open” when the valve rotates past 87°. The previous example describes a “dead band” of 3°. The electronic sensor mod 13 can be programmed to produce a different dead band and “dwell” at each end of the rotation. The “dwell” is the range of rotation through which the switch stays on after the switch turning on. Typically, settings may be programmed remotely or locally.

The electronic control 6 may communicate diagnostic information and enable sensor settings independently of any hard wiring controlling the modular pneumatic pilot valves 10. For example, diagnostic information and sensor settings may be communicated via separate wiring or via a wireless network. Additionally, the electronic control 6 may communicate with wireless handheld devices.

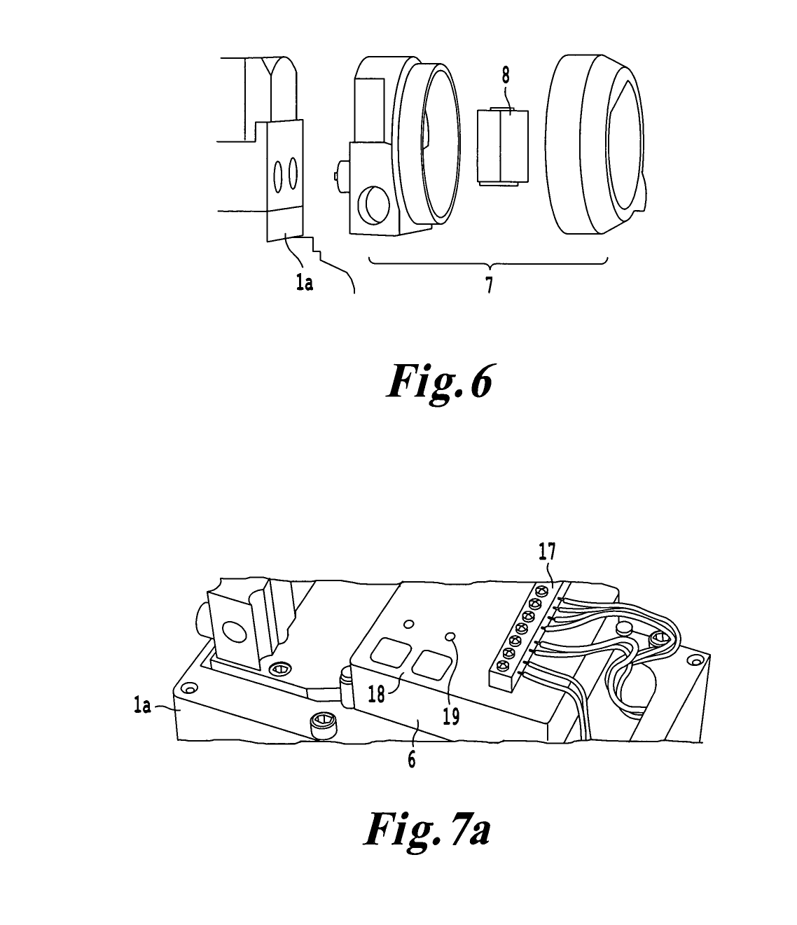

As shown in FIG. 6, a conduit section of the communication and control device 1 may include a linking explosion proof module (LEM) 7. In this non-limiting example, the LEM 7 typically includes at least one intrinsically safe barrier 8 in order to prevent the possibility of an explosion occurring in environments containing flammable gases. The LEM 7 itself is physically separated from the environment. All electrical connections wired after the LEM 7 connection are protected from discharging enough electrical energy to cause a spark capable of igniting any flammable gases in the area. Accordingly, as the sensor 14, pressure sensors, voltage sensors, electrical current sensors, and the solenoids in the modular pneumatic pilot valves 10 are wired to the protected connections of the LEM 7, these devices may be serviced safely without disconnecting incoming power.

As shown in FIG. 7a, an electronic control module 6 typically attaches to the top of main housing 1a. However, the location of the electronic control module may vary. For example, in another embodiment, the electronic control module can be attached to the housing cover 1b. In either case, the main housing 1a provides the foundation on which the electronic module 6 ultimately rests.

In one non-limiting embodiment, the electronic sensor module 13 is potted directly into the control module 6. Such a configuration facilitates assembly and enhances reliability. In another non-limiting embodiment, the electronic sensor module 13 is external to the control module and attached via wires.

The electronic module 6 typically contains the control and sensing circuitry used to detect the position of the rotary valve actuator 2. The electronic communication and control circuits may be contained in a fully autonomous, environmentally sealed, potted module. The module may be faced with a membrane pad 18. The membrane pad 18 may include one or more buttons for controlling the function of the rotary valve actuator 2 and for setting parameters associated with the sensor 14. While other methods of implementing control buttons may be used, membrane pads are particularly beneficial in wet environments because membrane pads resist penetration of moisture. The electronic control module may include one or more LEDs 19 in order to visually indicate the status of the rotary valve actuator or other information. In one exemplary embodiment, the terminal block 17 allows connections between the control module 6, modular pneumatic pilot valves 10, the process control system and, optionally, pressure or current sensors. In another embodiment, the pressure or current sensors are potted directly to the control module 6 (see FIG. 7d). The terminal block 17 is typically located on or near the electronic control module 6. Accordingly, the electronic module 6 provides a self-contained, easily replaceable, contamination resistant user interface with the communication and control device 1.

The control module 6 may receive pressure readings from pressure sensors on various ports on the manifold 4 and/or modular pneumatic pilot valves 10. Additionally, the magnitude of the voltage and/or electrical current supplied to solenoids may be measured and transmitted to the electronic control 6. The measurements may be stored in the control module 6, or transmitted to an asset management server 20.

As shown in FIG. 7b, the electronic control module 6 typically houses a processor 34, power converters 36 for conditioning any input voltage used to operate solenoid valves 10 and signal contacts 35. The signal contacts 35 are used to send valve actuator status information to a control unit, such as, for example a PC or a PLC. As discussed above, the sensor module 13 may be potted directly to the control module 6, or connected via wires.

FIG. 7c shows a schematic of the control module with a wireless transceiver 41 connected to the processor 41. The wireless transceiver may allow communication between the control and control device 1 and various external devices such as, for example, the asset management server 20, the operating system 22, and/or handheld devices.

FIG. 7d shows a schematic of the control module 6 with optional current sensors 37 and optional pressure sensors 38 potted directly to the control module 6. Also shown in the control module 6 is a communication interface 39 which may be used to communicate via a bus with an operating system. The communication interface 39 typically replaces the signal contacts 35. However, the communication interface 39 may also supplement the contacts 35. The current sensors 37 provide feedback in order to determine whether a particular solenoid on a modular pilot valve 10 is functional and also to provide data that may be used to develop preventive maintenance schedules. It is to be understood that the optional current sensors 37 may be replaced or supplemented with voltage sensors (not shown). The optional current sensors 37 may be located separately from the control module 6 or potted directly to the control module 6.

The optional pressure sensors 38 provide information regarding whether pressurized air is connected to the spool valve and what amount of pressure is available. For example, if the supply pressure to the spool valve falls below a particular value, the control module 6 may provide an output signal. The pressure information supplied by the optional pressure sensors also allows development of preventive maintenance schedules. For example, if a rotary valve actuator 2 requires more air pressure to operate than historically necessary, the rotary valve actuator 2 may be due for replacement. The pressure sensors 38 shown in FIG. 7d are potted directly to the control module 6. However, the pressure sensors 38 may be located elsewhere. Additionally, the air pressure monitored by the pressure sensors may be the pressure supplied to the modular pneumatic pilot valves, the manifold 4, the spool valve body 3 or another component.

FIG. 7c shows the communication interface 39 as located inside the control module. However, as with the position sensor 14, the communication interface may be potted directly to the control module 6, or optionally connected as a separate component via wires. The communication interface 39 may function via wired connections, wirelessly, or both.

FIG. 7e shows all the components of FIG. 7d with the addition of a wireless transceiver 41. The wireless transceiver 41 may supplement the communication performed via the communication interface 39.

In FIG. 7f, the wireless transceiver has taken the place of the communication interface 39 and all communication and control information sent to and from the communication module 6 is transmitted wirelessly. Typically, a power connection 40 provides a way of connecting an external power source to the control and control unit 1. However, internal power sources such as batteries may also be used.

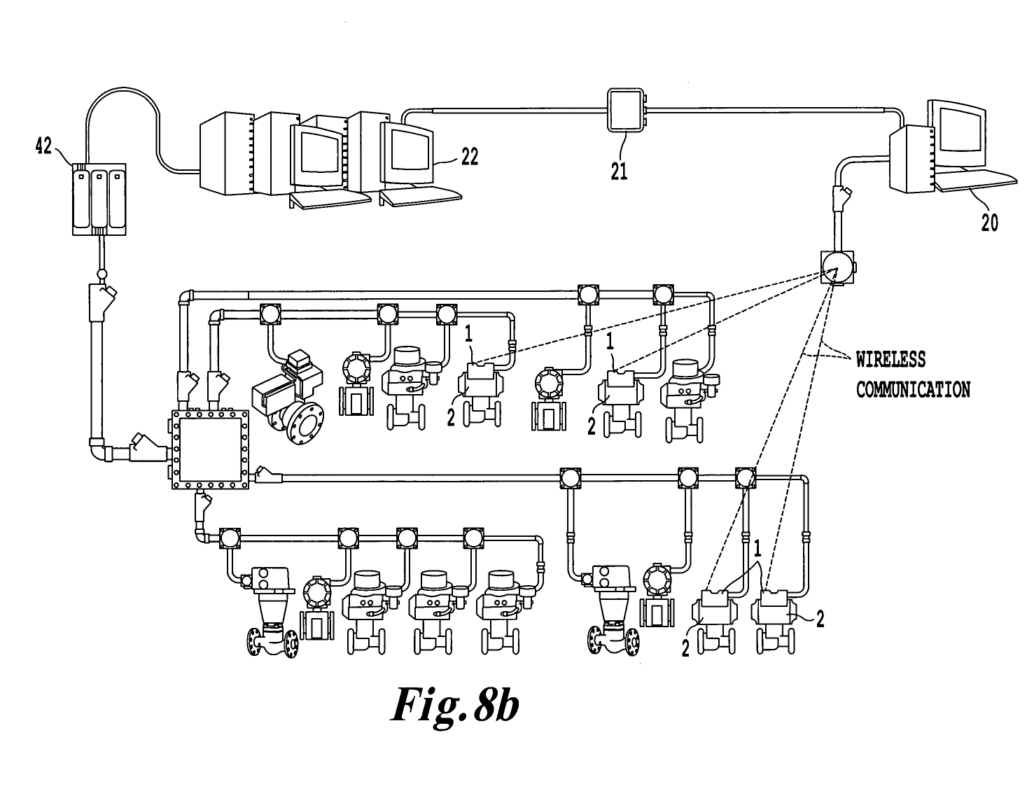

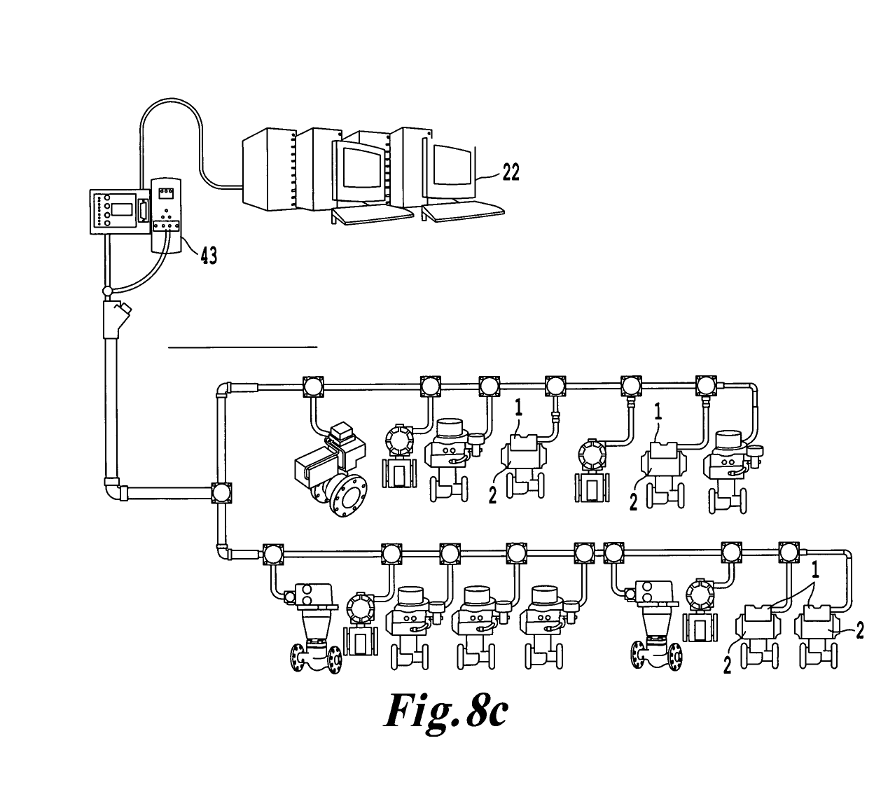

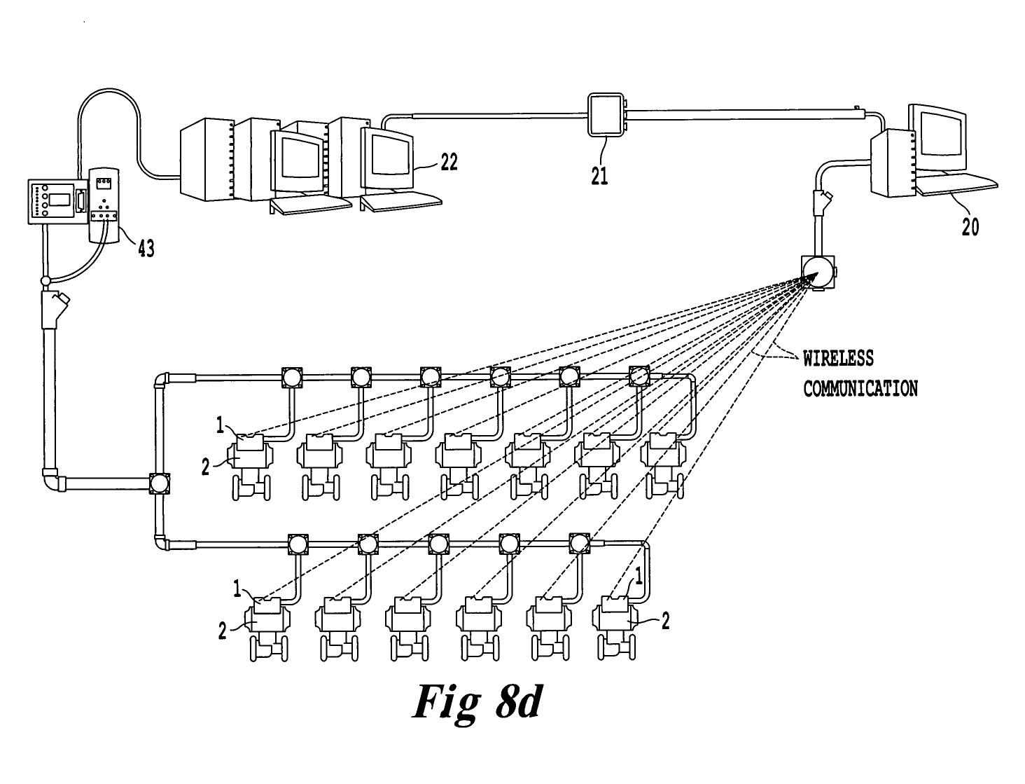

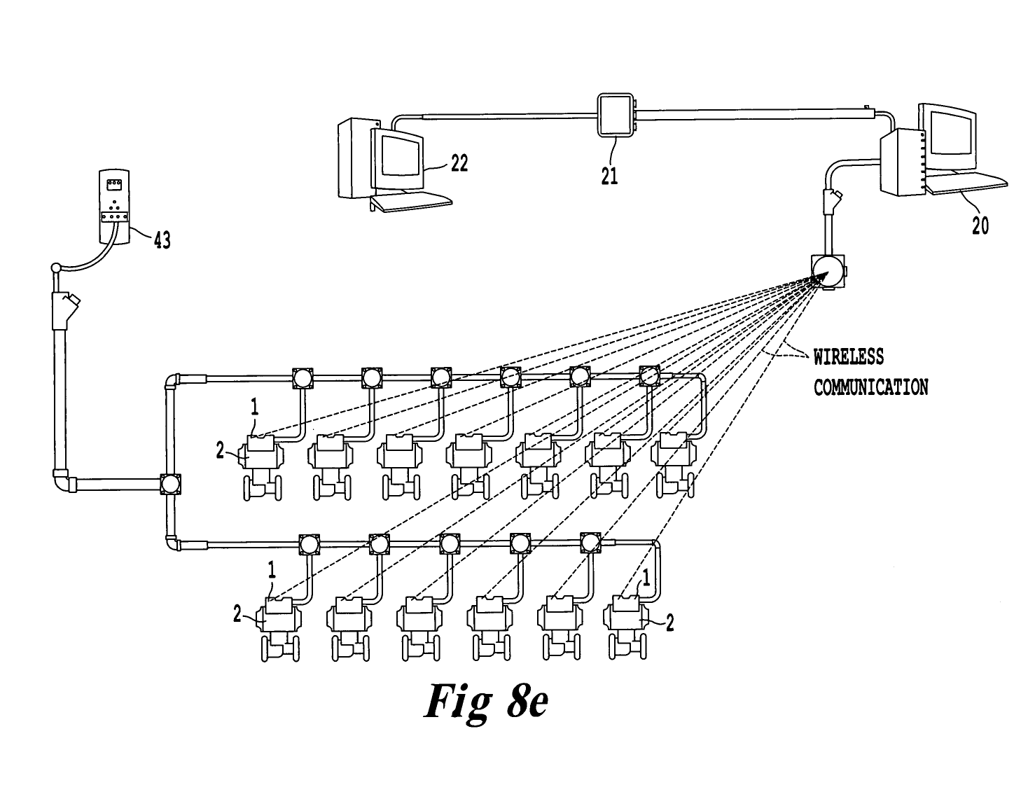

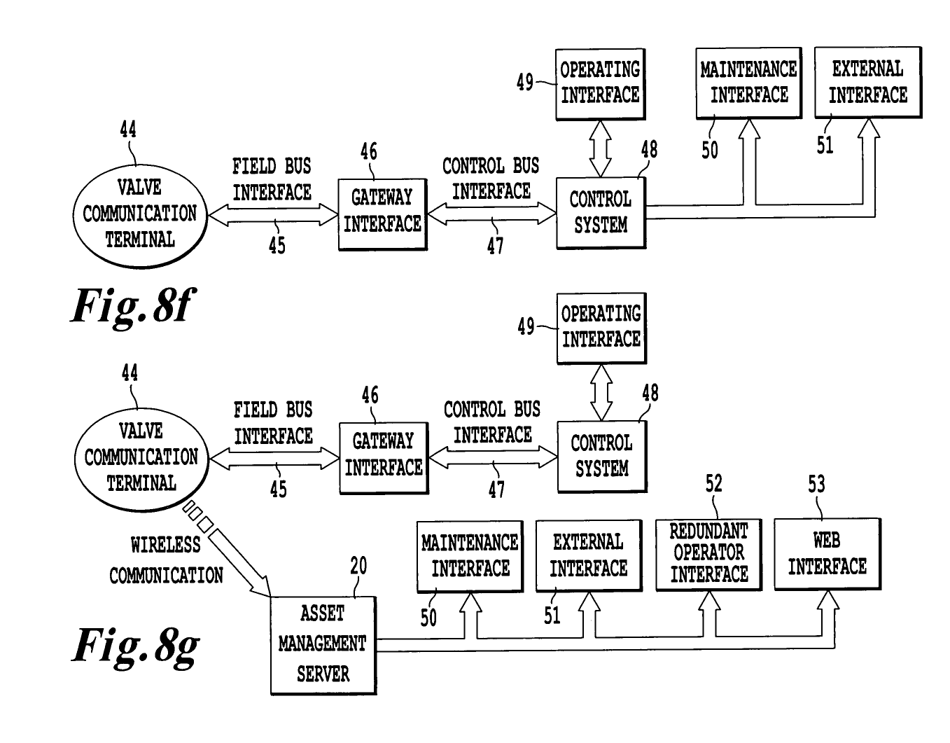

FIG. 8a shows multiple communication and control devices 1 connected to an I/O cabinet 42. As discussed earlier, the I/O can be 0-5 v, 4-20 ma, digital or other dedicated types of information transfer. In this non-limiting embodiment, the I/O cabinet 42 is separate from the operating system 22. However, the I/O cabinet 42 and operating system 22 may be combined as a single integrated unit.

FIG. 8b shows a number of communication and control devices 1 connected to an asset management server 20 via wireless communication and to an I/O cabinet via wires. In one non-limiting example of the invention, the asset management server is part of an enterprise network 21 and may be connected to operating system 22. With this arrangement, the asset management server will monitor parameters of the communication and control devices 1 in order to determine, for example, fluid flow paths and maintenance issues. In some embodiments, the communication and control devices 1 communicate with the asset management system via wireless networks. In other embodiments, the communication and control devices 1 use wires to communicate. The communication and control devices 1 may also combine wired and wireless communication. With regard to communication, it is to be understood that the term “wires” is not limited to standard electrical wiring, but also may include fiber optic connections.

The asset management server 20 may receive pressure readings regarding the amount of air pressure required to actuate a particular rotary valve actuator 2. The asset management server 20 can store this data to develop a trend line. Over time, the data may reveal that the air pressure required to actuate the rotary valve actuator 2 is gradually increasing or decreasing. Based on this data, maintenance technicians can perform predictive maintenance and determine root causes of the failure of valves. The asset management server 20 can be programmed to provide an alert when the amount of air pressure required to actuate a particular rotary valve actuator 2 reaches a programmed set-point. Historical data regarding voltage and current required to operate the modular pneumatic pilot valves 10 may also be used to develop maintenance schedules or to provide alerts regarding dysfunctional components. Pressure and power data and set-points for alerts or alarms may be stored in the asset management server 20 or in the electronic control 6.

These pressure, voltage, and electrical current data, combined with continuous position monitoring, enable firmware or software in the electronic control 6 or elsewhere to provide predictive maintenance and root cause failure analysis for optional local display (at the electronic control 6) or for remote telemetry into the asset management server 20.

The operating system 22 sends control signals wirelessly or via wires to the modular pneumatic pilot valves 10. The signals may be transmitted in the form of voltages or the signals may be digital information sent to the electronic control 6 for further conditioning.

FIG. 8b shows a network bus used in combination with wireless communication between various devices controlled by multiple communication and control devices 1. This implementation of communication and control corresponds to use of the electronic control module shown in FIG. 7c. Power supply 43 is shown as connected to the communication and control devices 1 via wires. However, as discussed above, power may be supplied to the communication and control devices through a self-contained power source. Accordingly, in the many embodiments, the power supply 43 may be replaced or supplemented with a self-contained power source such as a battery or batteries, uninterruptible power supply (UPS), power cell or the like.

FIG. 8c shows control and control implemented via a bus network. This particular embodiment corresponds to use of the electronic control module shown in FIG. 7d. Electric power is supplied to the communication and control devices 1 via power supply 43. It is to be understood that the power supply 43 may be either a wired connection to an external power source, or a self-contained power source such as a battery.

FIG. 8d shows the combination of a bus network with a wireless communication between the control and control devices 1 and an asset management server 20. Power is supplied to the control and control devices 1 via power supply 43.

FIG. 8e shows the control and control devices 1 connected to a power supply 43 via wires and in communication with the operating system 20 exclusively via wireless connection. In this non-limiting embodiment, all information exchange is performed via wireless connection.

FIG. 8f is a diagram of a typical implementation of a wired bus communication arrangement. In this non-limiting embodiment, the valve communication terminal 44 communicates via the field bus interface 45 with the gateway interface 46. The gateway interface 46 communicates with the control system 48 via the control bus interface 47. The control system 48 communicates with the operating interface 49, maintenance interface 50 and external interface 51 wirelessly, via wires, or via some combination of the two.

FIG. 8g. is a diagram of a combination of wired bus with wireless communication between the communication and control device 1 and the asset management server. In this non-limiting embodiment, the valve communication terminal 44 communicates with the gateway interface 46 via the field bus 45. The gateway interface 46 communicates with the control system 48 via the control bus 47. The control system 48 communicates with the operating interface 49 either wirelessly or via wired connection.

Regarding the wireless connection shown in FIG. 8g, the valve communication terminal 44 communicates with the asset management server 20 wirelessly. The asset management server 20 may then communicate with the maintenance interface 50, external interface 51, redundant operator interface 52, and web interface 53 (all optional) via wired or wireless connection.

Obviously, numerous modifications and variations of the present invention are possible in light of the above teachings. It is therefore to be understood that within the scope of the appended claims, the invention may be practiced otherwise than as specifically described herein.

What is claimed is:

1. A device for controlling a valve rotary actuator and communicating information regarding the valve rotary actuator, comprising:
a non-contact sensor which monitors, through a continuous range of rotation, the rotational position of a rotating unit connected to the valve rotary actuator;
a main housing including a pneumatic valve body integrally formed with the main housing, the pneumatic valve body accommodating a valve spool;
a sensor housing which supports the non-contact sensor and is connected to the main housing; and
a manifold including at least one pathway in fluid communication with the pneumatic valve body.

2. The device of claim 1, wherein the range of rotation is approximately 0 to 90 degrees.

3. The device of claim 1, wherein the non-contact sensor is a magnetic resistance sensor.

4. The device of claim 1, further comprising at least one pathway of fluid communication between the manifold and the rotary valve actuator.

5. The device of claim 4, wherein the at least one pathway comprises external tubing.

6. The device of claim 4, wherein the at least one pathway is internally formed within the manifold.

7. The device of claim 1, wherein the manifold is detachable from the valve rotary actuator.

8. The device of claim 1 further comprising an electronic control module supported by the main housing.

9. The device of claim 8, wherein the sensor and electronic control module consume electrical power of no more than 0.5 ma, and the electrical power is received via a branch of a circuit wired in parallel with another branch that carries a signal indicating whether a valve controlled by the valve rotary actuator is open.

10. The device of claim 8, wherein the sensor and electronic control module consume electrical power of no more than 0.5 ma, and the electrical power is received via a branch of a circuit wired in parallel with another branch that carries a signal indicating whether a valve controlled by the valve rotary actuator is closed.

11. The device of claim 8 further comprising a self-contained power source.

12. The device of claim 8, wherein the electronic control module transmits a signal when the rotating unit rotates by an amount defined by a parameter stored in the electronic control module.

13. The device of claim 12, wherein the amount defined by the parameter is different than the amount of actual rotation of the rotating unit.

14. The device of claim 1 further comprising a linking explosion proof module electrically connected between the electronic control module and an operating system external to the electronic control module.

15. The device of claim 1 further comprising at least one modular pneumatic pilot valve in fluid communication with the pneumatic valve body.

16. The device of claim 15, wherein the at least one pilot valve is operable with both 24 volts DC and 120 volts AC.

17. The device of claim 15 further comprising a voltage sensor which monitors voltage supplied to the at least one modular pneumatic pilot valve.

18. The device of claim 15 further comprising a current sensor which monitors electric current supplied to the at least one modular pneumatic pilot valve.

19. The device of claim 1 further comprising at least one pressure sensor.

20. The device of claim 1 further comprising a transmitter that transmits diagnostic information and monitoring information via wireless link.

21. The device of claim 1 wherein transmission of diagnostic and control information is done via wireless link.

22. The device of claim 1 wherein the device is configured to control an amount of rotation of the valve rotary actuator.

23. A device for controlling a valve rotary actuator and communicating information regarding the valve rotary actuator, comprising:
means for monitoring, through a continuous range of rotation, the rotational position of a valve rotary actuator;
a main housing including a pneumatic valve body integrally formed with the main housing, the pneumatic valve body accommodating a valve spool;
means for supporting the means for monitoring the rotational position of a valve rotary actuator; and
a manifold including a plurality of pathways in fluid communication with the pneumatic valve body.
